(19) United States
(12) Patent Application Publication
(10) Pub. No.: US 2018/0340793 A1
(43) Pub. Date: Nov. 29, 2018

(54) OVER-THE-AIR UPDATING OF VEHICLE CHARGING STATION UTILIZATION

(71) Applicant: Panasonic Automotive Systems Company of America, Division of Panasonic Corporation of North America, PEACHTREE CITY, GA (US)

(72) Inventor: DANIEL D. WILCOX, FARMINGTON HILLS, MI (US)

(73) Assignee: Panasonic Automotive Systems Company of America, Division of Panasonic Corporation of North America

(21) Appl. No.: 15/988,972

(22) Filed: May 24, 2018

Related U.S. Application Data
(60) Provisional application No. 62/510,581, filed on May 24, 2017.

(51) Int. Cl. G01C 21/36; G01C 21/34; B60L 11/18

(52) U.S. Cl. CPC G01C 21/3679; B60L 2240/72; B60L 11/1838; G01C 21/3469

(57) ABSTRACT

A motor vehicle includes a display screen viewable by a driver of the motor vehicle. An electronic processor is communicatively coupled to the display screen. The electronic processor wirelessly receives status information regarding battery recharging stations nearest to the motor vehicle. The electronic processor presents on the display screen the received status information.

### CROSS-REFERENCE TO RELATED APPLICATION

This application claims benefit of U.S. Provisional Application No. 62/510,581 filed on May 24, 2017, which the disclosure of which is hereby incorporated by reference in its entirety for all purposes.

### FIELD OF THE INVENTION

The disclosure relates to an infotainment system in a motor vehicle, and, more particularly, to an electric vehicle infotainment system that provides recharging station information.

### BACKGROUND OF THE INVENTION

Electric charging stations are becoming ever ubiquitous, and charging station utilization and installation has increased. Consumers whose vehicles require a recharge, especially those who are in a dire situation, need up-to-date charging station information. For example, the number of available charging ports per station, and the battery charging state of the vehicles currently being charged, may be important factors that consumers desire to know. However, some car manufactures merely report the geographical location of the nearest recharge station, similar to the nearest gas station.

Consider a vehicle where the total charge is at a state that requires a recharge, without which the vehicle may stall or become inoperable. Understanding where the nearest recharging station is does not constitute a complete picture. Several stations may be within reach. However, the closest charging station may have all its available charging ports currently utilized, which is why the number of ports per station is crucial information. But even this does not provide sufficient information for a user as the charging state of each vehicle at each charging station also crucial information.

Consider charging stations A and B, both with five charging ports and both currently having five vehicles charging. Thus, charging stations A and B are both being 100% utilized. Under these circumstances, which station should a driver of a vehicle go to for a charge? Even assuming that station A is closer than station B, having knowledge of the charging state of each vehicle (or a combination of metrics), may be useful in deciding which charging station to go to. Station A may be closer. However, at Station B, each vehicle charging state could be 90%, while the charging state of each vehicle at Station A could be 20% or lower. So, the probability of finding an open charging port at station B may be much higher because the vehicles there are likely to leave soon after being fully charged.

### SUMMARY

The present invention may provide a method to transmit up-to-date charging station information over-the-air (OTA). Such information may be essential for enabling a driver to make informed decisions.

In one embodiment, the invention comprises a motor vehicle including a display screen viewable by a driver of the motor vehicle. An electronic processor is communicatively coupled to the display screen. The electronic processor wirelessly receives status information regarding battery recharging stations nearest to the motor vehicle. The electronic processor presents on the display screen the received status information.

In another embodiment, the invention comprises a method of providing recharging station information in a motor vehicle. A display screen is provided in the motor vehicle. Status information regarding battery recharging stations nearest to the motor vehicle is wirelessly received in the motor vehicle. The received status information is presented on the display screen.

In yet another embodiment, the invention comprises a motor vehicle including a display screen viewable by a driver of the motor vehicle. An electronic processor is communicatively coupled to the display screen. The electronic processor wirelessly receives information regarding battery recharging stations nearest to the motor vehicle. The information indicates whether an identified battery recharging station has unoccupied charging ports and/or how long it will be until the identified battery recharging station has an unoccupied charging port. The electronic processor presents on the display screen the received information.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular recharging station information arrangement of the present invention.

FIG. 2 is an example presentation on the display screen of the vehicular recharging station information arrangement of FIG. 1.

FIG. 3 is another example presentation on the display screen of the vehicular recharging station information arrangement of FIG. 1.

FIG. 4 is a flow chart of one embodiment of a method of the present invention for providing recharging station information in a motor vehicle.

### DETAILED DESCRIPTION OF THE PREFERRED EMBODIMENTS

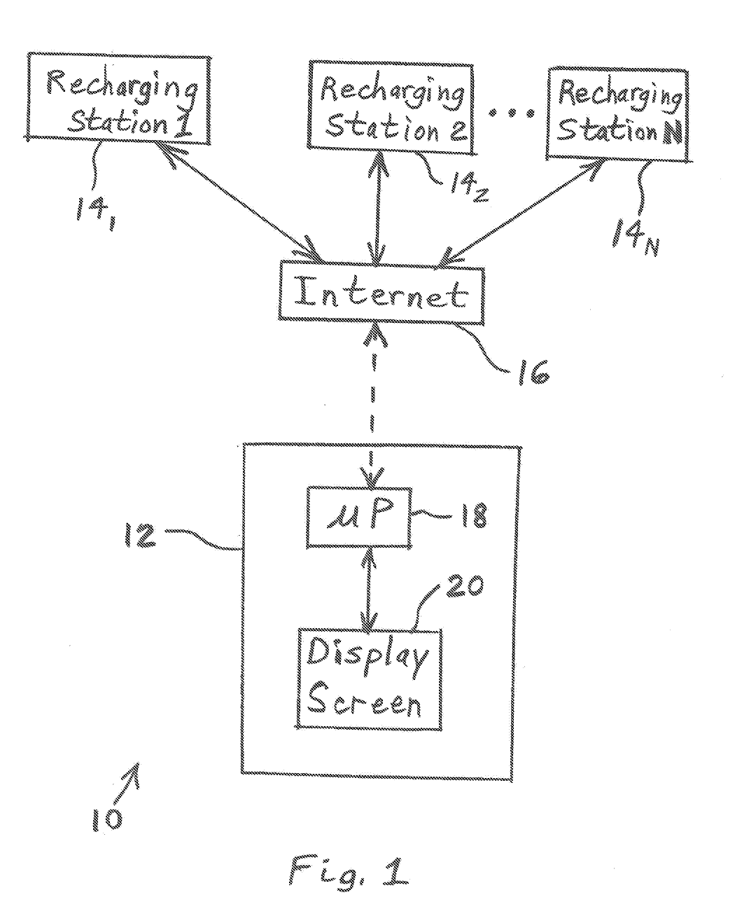

FIG. 1 illustrates one embodiment of a recharging station information arrangement 10 of the present invention for a motor vehicle 12, including N number of recharging stations 14₁ . . . 14_{N}, the Internet 16, an electronic processor 18, and a display screen 20. Recharging stations 14 report to a web site on Internet 16 information about the current usage or status of recharging stations 14, and about the charging status and states of vehicles being recharged, or soon to be recharged, by recharging stations 14.

Electronic processor 18 may wirelessly access Internet 16 and the web site to which the recharging station information is reported. Electronic processor 18 may retrieve the recharging station information and present the recharging station information on display screen 20. Electronic processor 18 may process the recharging station information, extract portions of the information that are of particular interest to the driver, and present the extracted information on display screen 20 in a form that is quickly and easily understood by the driver.

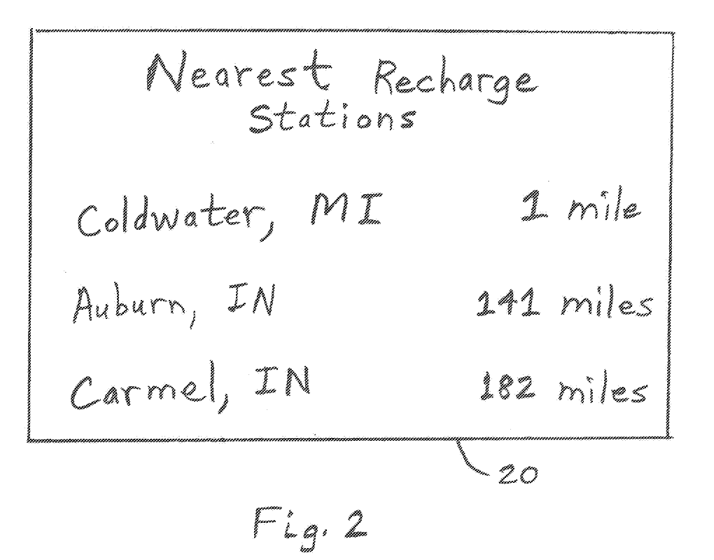

FIG. 2 illustrates an example presentation of recharging station information on display screen 20. Specifically, FIG. 2 provides a possible GUI (Graphical User Interface) layout displaying information on the nearest re-charging stations. The presented information includes a list of the cities of the nearest recharge stations, and the distance to each listed recharge station. The driver/user may obtain more specific information about each listed recharge station by selecting a particular listed recharge station, such as by touching a line on a touch-sensitive screen 20 corresponding to one of the three listed recharge stations.

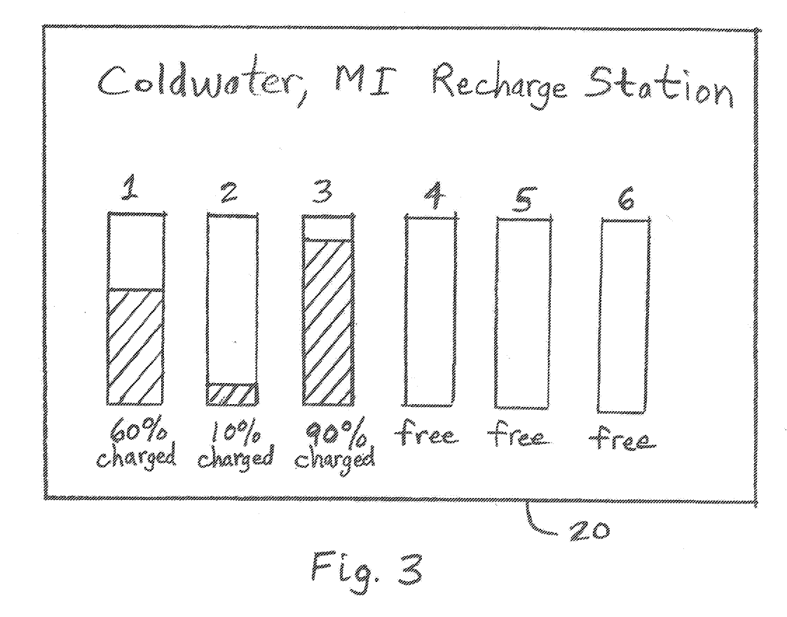

If the user selects the Coldwater, Mich. recharge station, he may thereby cause display screen 20 to present information specific to the Coldwater, Mich. recharge station, as shown in FIG. 3. FIG. 3 illustrates another example presentation on display screen 20 that may be displayed in response to the user selecting the Coldwater, Mich. recharge station. More specifically, FIG. 3 illustrates a GUI with important information for the selected re-charge station located in Coldwater, Mich. It is clear that six charging ports 1-6 are available (e.g., one charging port per vehicle). Three ports 1-3 of the six are in use, with the vehicle on port 1 being charged approximately 60%; the vehicle on port 2 being charged approximately 10%; and the vehicle on port 3 being charged approximately 90%. Thus, the driver may assume that port 3 will be free and available for use relatively soon. The last three ports 4-6 are shown to currently be free and available for use.

The invention has been described as presenting the charging status of each individual vehicle at the selected recharging station. However, in another embodiment, instead of a report of each individual vehicle's battery re-charging status, a report of the overall charging station utilization is presented (e.g., with reference to the example of FIG. 3, “three of six ports are currently being utilized”). Alternatively, the average vehicle battery re-charging status at a particular charging station (e.g., with reference to the example of FIG. 3, (60%+10%+90%)/3=53%) is presented (e.g., “the average vehicle battery is charged at 53% of capacity”). As another alternative, the average vehicle battery re-charging status, counting unutilized ports as 100%, is presented. For example, using the charging statuses of the six ports in FIG. 3, the average vehicle battery re-charging status is 83%=(60%+10%+90%+100%+100%+100%)/6. Thus, display screen 20 may indicate that “the average vehicle battery at all six ports is charged at 83% of capacity”.

This information can also be programmed into the car electric system software or hardware (e.g., the engine control unit (ECU), dashboard, central processing unit (CPU), and computer) to further take advantage of this information, such as for automation purposes.

The recharging station status information may also include an estimated period of time that at least one other motor vehicle is expected to continue to be charged at each recharging station. For example, if one vehicle is only 10% charged, the information may include an estimate of two hours before the vehicle is fully charged and the associated charging port becomes available. On the other hand, if another vehicle is 90% charged, the information may include an estimate of twelve minutes before the vehicle is fully charged and the associated charging port becomes available.

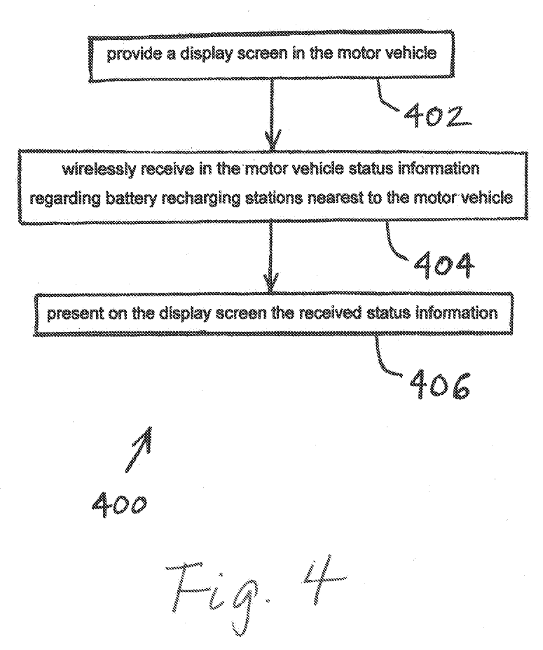

FIG. 4 illustrates one embodiment of a method 400 of the present invention for providing recharging station information in a motor vehicle. In a first step 402, a display screen is provided in the motor vehicle. For example, display screen 20 may be permanently installed in motor vehicle 12.

Next, in step 404, status information regarding battery recharging stations nearest to the motor vehicle is wirelessly received in the motor vehicle. For example, electronic processor 18 may wirelessly access Internet 16 and a web site to which the recharging station information is reported. Electronic processor 18 may then receive the recharging station status information from the web site.

In a final step 406, the received status information is presented on the display screen. For example, the recharging station status information received from the web site may be presented on display screen 20.

The invention has been described as the vehicle communicating with recharge stations via the Internet. However, it is also possible within the scope of the invention for the vehicle to communicate directly with the recharge stations or to communicate with the recharge stations via another type of network.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can he made by those skilled in the art upon reading this disclosure and may be made without departing from the spirit of the invention.

What is claimed is:

1. A motor vehicle, comprising:
a display screen viewable by a driver of the motor vehicle; and
an electronic processor communicatively coupled to the display screen, the electronic processor being configured to:
wirelessly receive status information regarding battery recharging stations nearest to the motor vehicle; and
present on the display screen the received status information.

2. The vehicle of claim 1 wherein the status information includes a number of unoccupied charging ports at each said recharging station.

3. The vehicle of claim 2 wherein the status information includes a number of occupied charging ports at each said recharging station.

4. The vehicle of claim 1 wherein the status information includes an indication of a charge percentage of at least one other motor vehicle being charged at each said recharging station.

5. The vehicle of claim 4 wherein the status information includes an indication of a charge percentage of each other motor vehicle being charged at each said recharging station.

6. The vehicle of claim 4 wherein the status information includes an indication of an average charge percentage of all other motor vehicles being charged at each said recharging station.

7. The vehicle of claim 1 wherein the status information includes an indication of an estimated period of time that at least one other motor vehicle is expected to continue to be charged at each said recharging station.

8. A method of providing recharging station information in a motor vehicle, comprising the steps of:
providing a display screen in the motor vehicle;
wirelessly receiving in the motor vehicle status information regarding battery recharging stations nearest to the motor vehicle; and
presenting on the display screen the received status information.

9. The method of claim 8 wherein the status information includes a number of unoccupied charging ports at each said recharging station.

10. The method of claim 9 wherein the status information includes a number of occupied charging ports at each said recharging station.

11. The method of claim 8 wherein the status information includes an indication of a charge percentage of at least one other motor vehicle being charged at each said recharging station.

12. The method of claim 11 wherein the status information includes an indication of a charge percentage of each other motor vehicle being charged at each said recharging station.

13. The method of claim 11 wherein the status information includes an indication of an average charge percentage of all other motor vehicles being charged at each said recharging station.

14. The method of claim 8 wherein the status information includes an indication of an estimated period of time that at least one other motor vehicle is expected to continue to be charged at each said recharging station.

15. A motor vehicle, comprising:
a display screen viewable by a driver of the motor vehicle; and
an electronic processor communicatively coupled to the display screen, the electronic processor being configured to:
wirelessly receive information regarding battery recharging stations nearest to the motor vehicle, the information indicating whether an identified said battery recharging station has unoccupied charging ports and/or how long it will be until the identified battery recharging station has an unoccupied charging port; and
present on the display screen the received information.

16. The vehicle of claim 15 wherein the information includes a number of unoccupied charging ports and a number of occupied charging ports at each said recharging station.

17. The vehicle of claim 15 wherein the information includes an indication of a charge percentage of at least one other motor vehicle being charged at each said recharging station.

18. The vehicle of claim 17 wherein the information includes an indication of a charge percentage of each other motor vehicle being charged at each said recharging station.

19. The vehicle of claim 17 wherein the information includes an indication of an average charge percentage of all other motor vehicles being charged at each said recharging station.

20. The vehicle of claim 15 wherein the information includes an indication of an estimated period of time that at least one other motor vehicle is expected to continue to be charged at each said recharging station.
